(19) United States
(12) Patent Application Publication
(10) Pub. No.: US 2021/0127723 A1
(43) Pub. Date: May 6, 2021

(54) FISH PRODUCTS AND METHODS OF MAKING FISH PRODUCTS

(71) Applicants: Rene Ejner DAMMAND, Horsens (DK); Peter LUXHOEI, Aalborg (DK); Steven DAMATO, Washington, DC (US)

(72) Inventors: Rene Ejner DAMMAND, Horsens (DK); Peter LUXHOEI, Aalborg (DK); Steven DAMATO, Washington, DC (US)

(21) Appl. No.: 16/612,255

(22) PCT Filed: Oct. 2, 2019
(86) PCT No.: PCT/US19/54305

§ 371 Date: Nov. 8, 2019

Related U.S. Application Data
(60) Provisional application No. 62/740,181, filed on Oct. 2, 2018.

(51) Int. Cl. A23L 17/00; A23L 27/40; A23P 30/20; A22C 25/00

(52) U.S. Cl. CPC A23L 17/70; A23L 27/40; A23V 2002/00; A23P 30/20; A22C 25/00; A23L 17/75

(57) ABSTRACT

The disclosure provides fish products and methods of making fish products, including mixing pieces of frozen fish and salt, and extruding the mixture of fish and salt into a fish product, wherein the fish product includes only the salt as an additive.

### CROSS-REFERENCE TO RELATED APPLICATIONS

The present application for patent claims priority to U.S. Application No. 62/740,181 entitled “FISH PRODUCT AND METHODS OF MAKING FISH PRODUCTS” filed Oct. 2, 2018, which is hereby expressly incorporated by reference in its entirety herein.

### FIELD

The disclosure provides fish products and methods of making fish products.

### BACKGROUND

Consumer fish products (e.g., fish patties, nuggets, or sticks) comprise additives such as flour, sugar, eggs, and phosphates, to bind the fish product together and for taste. For example, fish nuggets and fish sticks, which are generally marketed for children, include flour (e.g., breading) to provide a crispy exterior when cooked. Although such products have been commercially sold for many years, they include ingredients that may not be deemed “healthy,” and thus are not desired by health conscious consumers.

### SUMMARY

The disclosure provides fish products that do not include additives (e.g., binders) traditionally used in consumer fish products, and methods of making the same. For example, in one aspect, the disclosure provides for a method of making a fish product comprising mixing pieces of frozen fish and salt; and extruding the mixture of fish and salt into a fish product, wherein the fish product only includes the salt as an additive, e.g., does not comprise any additives other than salt.

In some aspects, salt is added to frozen fish at a temperature of −2° C. to −4° C. In other aspects, the mixing and extruding may be performed at a temperature of −2° C. to −4° C. In other aspects, the mixing is iteratively performed while adjusting the temperature within −2° C. to −4° C. until binding of the pieces of the fish is achieved, thereby determining a binding temperature, and performing extruding at the binding temperature. In yet other aspects, the extruding includes setting an extruder performing the extruding to the binding temperature. The extruding may further comprise forming the fish product, as it exits an extruder performing the extruding, into, for example, a shape of a fish.

In some aspects, an amount of the salt in the fish product may be from 0.25% to 2.5% w/w of the fish product. In other aspects, the fish product does not comprise flour, sugar, oil, starch, an egg product, phosphate, powders, spices, yeast, vitamins, minerals, and/or coloring agents. In yet other aspects, the fish product only comprises the salt as a binding agent, e.g., does not comprise a water binding agent, such as a polyphosphate.

These and other aspects are discussed throughout the disclosure.

### BRIEF DESCRIPTION OF THE FIGURES

FIG. 1 is a flow chart of an exemplary method described herein.

FIG. 2 is a flow chart of an exemplary method described herein.

FIG. 3 is a picture of an exemplary aspect of mixing frozen fish.

FIG. 4A and FIG. 4B are pictures of fish products that have been extruded and cut into the shape of fish.

### DETAILED DESCRIPTION

The disclosure provides for fish products and methods of making the same. The methods involve mixing pieces of frozen fish and salt, and extruding the mixture of fish and salt into a fish product, wherein the fish product does not comprise any additives other than salt. The inventors surprisingly discovered that the fish products, when cooked, do not readily fall apart and thus maintain their integrity.

Fish

The methods described herein can be used with any fish in which a fish product is desired. For example, fish that may be used in the methods described herein include, but are not limited to, salmon, cod, tuna, mahi mahi, pollack, haddock, hoki, plaice, and saith.

The methods described herein involve mixing frozen fish. In some aspects, the fish is frozen only once. For example, many commercial fishing vessels prepare frozen blocks of fish, which are sent to food producers for making fish products. The frozen fish described herein may be the fish obtained from such commercial fishing vessels. Without being bound by any theory, fish frozen more than once have a higher moisture content (due to break down of the cellular structure of the proteins) than fish frozen only once. In other aspects, the frozen fish described herein has a low moisture content.

Mixing and Extruding

The methods described herein involve mixing frozen fish and salt, and extruding the mixture of fish and salt into a fish product. The salt may be added to the frozen fish at a temperature of at −2° C. to −4° C. The mixing of the frozen fish and salt may also be performed at −2° C. to −4° C. The temperature of the fish may fall 1° C. to 2° C. after the salt has been added. As a result, part of the mixing may be performed at −3° C. to −6° C., −4° C. to −6° C., or −4° C. to −5° C.

The mixing may be iteratively performed while adjusting the temperature within −2° C. to −4° C. until binding of the pieces of fish is achieved, thereby defining a binding temperature, and the extruding may be performed at the binding temperature. The step of extruding may also be performed at −2° C. to −4° C.

The mixing and extruding steps may be performed with any variety of mixing devices and extruders, respectively. For example, but not limited hereto, the mixing may be performed using a bowl cutter. Also, for example but not limited hereto, the extruding may be performed using a commercially available device, such as the vacuum filler HP30E available from VEMAG Maschinenbau GmbH, Verden, Germany. The mixing device and extruder may include a thermometer (either internal or external to the device) or other device that measures the temperature of the products being mixed or extruded. The mixing device and extruder may be set to a desired temperature. For example, the extruder may be set to the binding temperature.

The temperature used may vary depending on a particular fish being processed. Without being bound by any theory, it is believed that the lower fat content of the fish, the lower the temperature used and, similarly, a fish with a higher fat content will be more flexible on temperature since they have more enzymes to activate. For example, Table 1 describes exemplary temperatures for processing (e.g., adding salt to frozen fish, mixing, extruding) specific fish.

TABLE 1
Processing temperatures for specific fish

| Fish | Temperature |
|---|---|
| Salmon | −3.5° C. |
| Cod | −3.0° C. |
| Pollack | −2.5° C. |

Salt

The methods described herein involve mixing frozen fish with salt. Salt may be added in an amount of 0.25% to 2.5%, 0.25% to 1.25%, 0.25% to 0.75% w/w of the fish product. In other aspects, salt is added in an amount of 0.25%, 0.4%, 0.5%, 0.6%, 0.7%, 0.75%, 0.8%, 0.9%, 1.0%, 1.1%, 1.2%, 1.25%, 1.5%, 1.75%, 2.0%, 2.25%, or 2.5% w/w of the fish product. For example, if 1000 grams of fish is used, then 2.5 grams of salt may be added (i.e., the amount of salt added is 0.25% w/w of the fish product).

Additives (or Binders)

The disclosure provides fish products that do not include additives (e.g., binders) traditionally used in consumer fish products. Instead, the salt used in the fish product is the only additive or binder. In some aspects, the fish products, and methods of making the same, do not include additives (or binders or emulsifiers) such as flour, sugar, oil (e.g., canola), starch (e.g., potato, corn), eggs (or egg whites), phosphate(s) (e.g., polyphosphates), powders (e.g., onion, garlic), spices, yeast, vitamins, minerals, and/or coloring agents.

Fish Products

The disclosure provides fish products made by any of the methods described herein. The fish product may have any desired shape, such as the shape of a fish, a circle, or rectangle. The fish product may consist of fish and salt. The fish product may have salt in an amount of 0.25% to 2.5%, 0.25% to 1.25%, 0.25% to 0.75% w/w of the fish product. The fish product may have salt in an amount of 0.25%, 0.4%, 0.5%, 0.6%, 0.7%, 0.75%, 0.8%, 0.9%, 1.0%, 1.1%, 1.2%, 1.25%, 1.5%, 1.75%, 2.0%, 2.25%, or 2.5% w/w of the fish product.

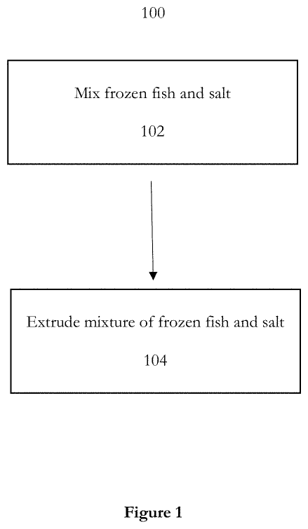

Referring to FIG. 1, in operation, an example method 100 of making a fish product may comprise any combination of actions described herein.

In an aspect, method 100 includes, at 102, mixing pieces of frozen fish and salt. For example, in an aspect a bowl cutter may be operated to mix the frozen fish and the salt as described herein.

Further, in an aspect, method 100 includes, at 104, extruding the mixture of fish and salt into a fish product, wherein the fish product includes only the salt as an additive. For example, in an aspect, an extruder may be operated to receive the mixture of frozen fish and salt and output the fish product, as described herein.

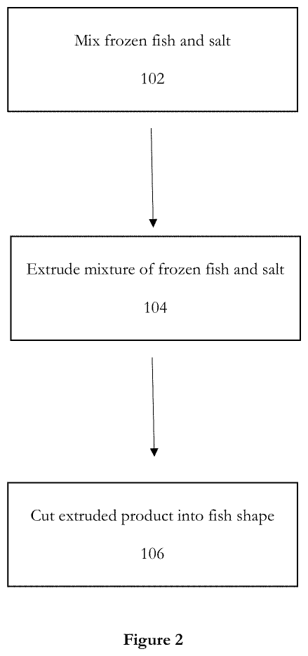

Referring to FIG. 2, optionally, besides including the extruding (at 102) and the mixing (at 104), method 100 may additionally include, at 106, cutting the fish product as it exits an extruder extruding the fish product. For example, in an aspect, a cutting blade (e.g., rotating knife) may be operated to periodically cut through the output of the extruder to define pieces of the fish product having a given thickness that is a function of a speed of the fish product being output and a time period of operating of the cutting blade.

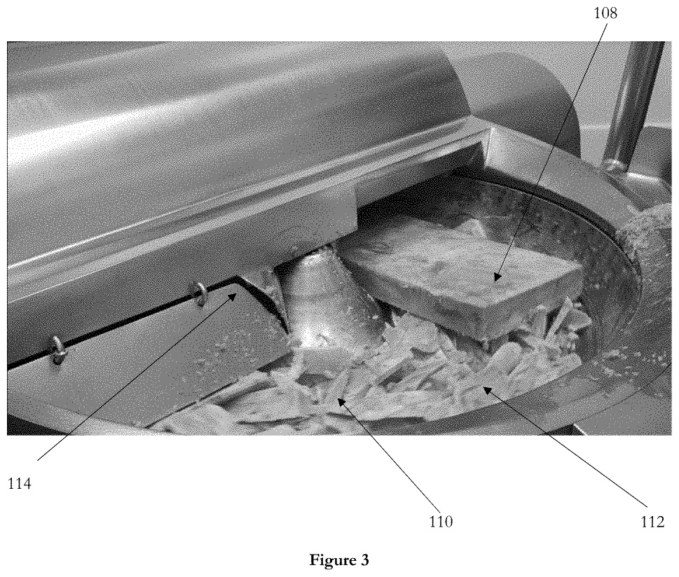

Referring to FIG. 3, in one example of the mixing (at 102 in FIG. 1), a block of frozen fish 108 is cut into fish pieces 110 and mixed with salt 112 by a mixing device 114, as further described herein.

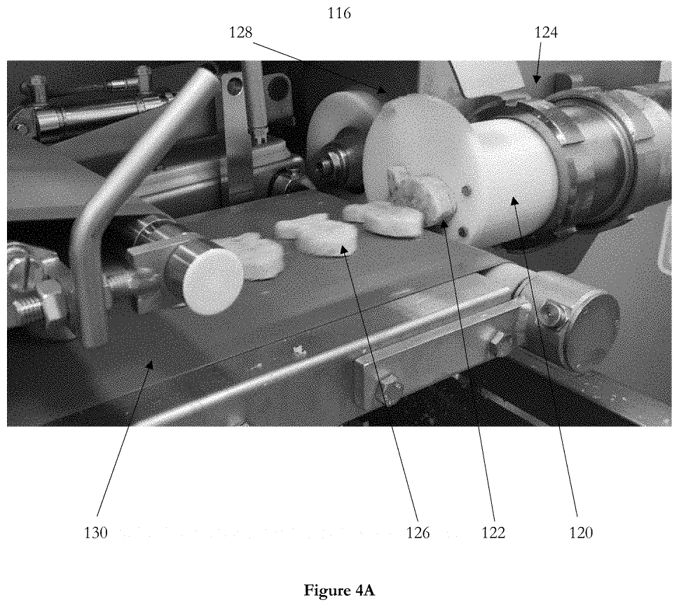

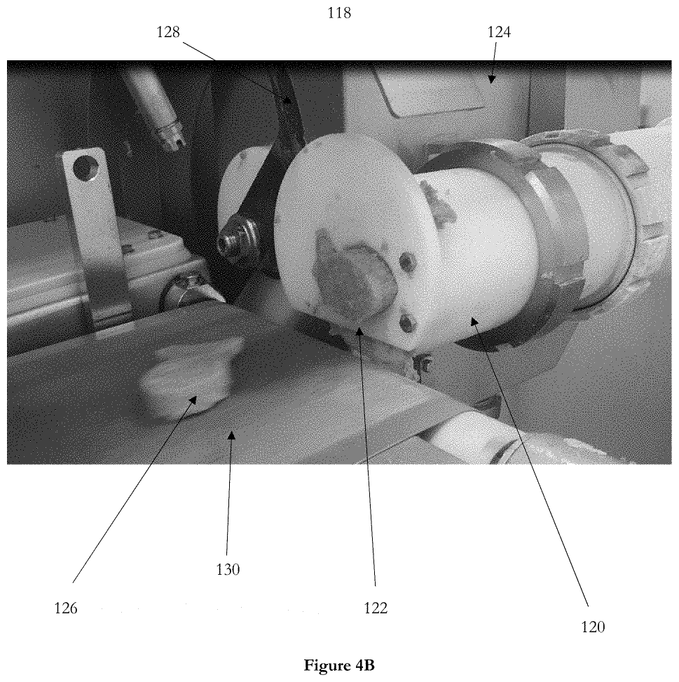

Referring to FIGS. 4A and 4B, in one example of an output of the extruding (at 104 in FIG. 1), different types of fish product, e.g., cod fish product 116 (FIG. 4A) and salmon fish product 118 (FIG. 4B), exit a forming plate 120 at an output 122 of an extruder 124, are cut into fish product pieces 126 by a cutting blade 128, and are received by a conveyor belt 130, which moves the fish product pieces 126 into a packaging process for packaging and shipment.

It should be understood that the examples described herein are for purposes of understanding, and that the scope of the present disclosure should be defined by the following claims.

1. A process for making a fish product, comprising
mixing pieces of frozen fish and salt; and
extruding the mixture of fish and salt into a fish product, wherein the fish product includes only the salt as an additive.

2. The method of claim 1, wherein the frozen fish is only frozen once.

3. The method of claim 1, wherein at least part of the mixing is performed at a temperature of −2° C. to −4° C.

4. The method of claim 1, wherein the extruding is performed at a temperature of −2° C. to −4° C.

5. The method of claim 1, wherein an amount of the salt is from 0.25% to 2.5% w/w of the fish product.

6. The method of claim 1, wherein an amount of the salt is from 0.25% to 0.75% w/w of the fish product.

7. The method of claim 1, wherein the mixing is performed by a bowl cutter.

8. The method of claim 1, wherein the mixing is iteratively performed while adjusting a temperature within −2° C. to −4° C. until binding of the pieces of the fish is achieved, thereby defining a binding temperature.

9. The method of claim 8, wherein the extruding is performed at the binding temperature.

10. The method of claim 9, further comprising setting an extruder performing the extruding to the binding temperature.

11. The method of claim 1, wherein the extruding further comprises cutting the fish product as it exits an extruder extruding the fish product.

12. The method of claim 11, wherein the extruding extrudes the fish product in a shape of a fish.

13. The method of claim 1, wherein the fish product does not comprise a water binding agent.

14. The method of claim 1, wherein the fish product does not comprise flour, sugar, oil, starch, an egg product, phosphate, powders, spices, yeast, vitamins, minerals, and/or coloring agents.

15. A fish product made by the process of claim 1.

16. An extruded fish product consisting of fish and salt.

17. The extruded fish product of claim 16, wherein an amount of the salt is from 0.25% to 2.5% w/w of the fish product.

18. The extruded fish product of claim 16, wherein the amount of the salt is from 0.25% to 0.75% w/w of the fish product.

19. A process for making a fish product, comprising
adding salt to frozen fish at a temperature of −2° C. to −4° C.;
mixing the frozen fish and salt;
extruding the mixture of fish and salt into a fish product, wherein the fish product includes only the salt as an additive.

20. The method of claim 19, wherein the frozen fish is only frozen once.

21. The method of claim 19, wherein at least part of the mixing is performed at a temperature of −2° C. to −4° C.

22. The method of claim 19, wherein the extruding is performed at a temperature of −2° C. to −4° C.

23. The method of claim 19, wherein an amount of the salt is from 0.25% to 2.5% w/w of the fish product.

24. The method of claim 19, wherein an amount of the salt is from 0.25% to 0.75% w/w of the fish product.

25. The method of claim 19, wherein the mixing is performed by a bowl cutter.

26. The method of claim 19, wherein the mixing is iteratively performed while adjusting a temperature within −2° C. to −4° C. until binding of the pieces of the fish is achieved, thereby defining a binding temperature.

27. The method of claim 26, wherein the extruding is performed at the binding temperature.

28. The method of claim 27, further comprising setting an extruder performing the extruding to the binding temperature.

29. The method of claim 19, wherein the extruding further comprises cutting the fish product as it exits an extruder extruding the fish product.

30. The method of claim 29, wherein the extruding extrudes the fish product in a shape of a fish.

31. The method of claim 19, wherein the fish product does not comprise a water binding agent.

32. The method of claim 19, wherein the fish product does not comprise flour, sugar, oil, starch, an egg product, phosphate, powders, spices, yeast, vitamins, minerals, and/or coloring agents.

33. The method of claim 19, wherein the frozen fish is salmon and salt is added at a temperature of −3.5° C., the frozen fish is cod and salt is added at a temperature of −3.0° C., or the frozen fish is pollack and salt is added at a temperature of −2.5° C.

34. A fish product made by the process of claim 19.
